(19) United States
(12) Patent Application Publication
(10) Pub. No.: US 2021/0354156 A1
(43) Pub. Date: Nov. 18, 2021

(54) SPOUTING CONTAINER

(71) Applicants: SHISEIDO COMPANY, LTD., Tokyo (JP); YOSHINO KOGYOSHO CO., LTD., Tokyo (JP)

(72) Inventors: Tsuyoshi SASAKI, Chuo-ku, Tokyo (JP); Hiromichi SAITO, Koto-ku, Tokyo (JP); Toru TOMA, Koto-ku, Tokyo (JP)

(73) Assignees: SHISEIDO COMPANY, LTD., Tokyo (JP); YOSHINO KOGYOSHO CO., LTD., Tokyo (JP)

(21) Appl. No.: 17/290,403

(22) PCT Filed: Oct. 31, 2019
(86) PCT No.: PCT/JP2019/042867

§ 371 Date: Apr. 30, 2021

(30) Foreign Application Priority Data
Oct. 31, 2018 (JP) 2018-205392

(51) Int. Cl. B05B 11/00

(52) U.S. Cl. CPC B05B 11/3084; B05B 11/3052; B05B 11/3083

(57) ABSTRACT

A dispensing container capable of changing the ratio between the amounts of two kinds of contents to be dispensed, includes two container bodies, two pumps including two stems, an adjusting member configured to press the stems and to be rotatable about an axis extending in a substantially vertical direction, and a pressing head configured to, in response to a depressing operation, rotate about an axis extending in a substantially horizontal direction, to thereby depress the stems via the adjusting member. The adjusting member includes a plurality of pressing portions against which the stems are pressed, and when the adjusting member is rotated about the axis, a depressing stroke of the one of the plurality of pressing portions on the side of one of the stems becomes shorter, and a depressing stroke of the other one of the plurality of pressing portions on the side of the other stem becomes longer.

### CROSS-REFERENCE TO RELATED APPLICATION

This application claims priority to Japanese Patent Application No. 2018-205392, filed on Oct. 31, 2018, the entire contents of which are incorporated herein by reference.

### TECHNICAL FIELD

The present disclosure relates to a dispensing container capable of changing the ratio between the amounts of two kinds of contents to be dispensed.

### BACKGROUND

As a type of container that contains cosmetic lotions, hair dyes, or the like, a dispensing container that contains two kinds of contents separately and that, when used, mixes the contents before dispensing them has been proposed (refer to, for example, Patent Literature [PTL] 1).

### CITATION LIST

### Patent Literature

PTL 1: JP 3651773 B2

### SUMMARY

### Technical Problem

The problem with the dispensing container described in PTL 1, however, is that although it is possible to select whether to dispense equal amounts of the two kinds of contents at the same time or to dispense only one of the contents, it is not possible to dispense the two kinds of contents by changing the ratio between the amounts of the contents to be dispensed. The dispensing container can hardly be used to finely adjust the ratio between the amounts of the two contents to be dispensed in accordance with skin and hair conditions of the user, and there is room for improvement in this respect.

It would be helpful to provide a dispensing container that is capable of changing the ratio between the amounts of two kinds of contents to be dispensed.

### Solution to Problem

A dispensing container according to an embodiment of the present disclosure includes:

two container bodies configured to respectively contain two kinds of contents;

two pumps respectively including two protruding stems configured to be depressed in an upwardly urged state, the two pumps being configured to respectively pump the two kinds of contents in the two container bodies upward in response to the two stems being depressed;

an adjusting member configured to directly or indirectly press the two stems and configured to be rotatable about an axis extending in a substantially vertical direction that is located between the two container bodies in a plan view; and

a pressing head configured to, in response to a depressing operation, rotate about an axis extending in a substantially horizontal direction that is parallel to a direction in which the two container bodies are arranged, to thereby depress the two stems via the adjusting member, wherein

the adjusting member includes a plurality of pressing portions against which the two stems are directly or indirectly pressed, and when the adjusting member is rotated about the axis extending in the substantially vertical direction, one of the plurality of pressing portions on a side of one of the two stems approaches the axis extending in the substantially horizontal direction in the plan view, whereby a depressing stroke of the one of the plurality of pressing portions on the side of the one of the two stems in response to a depressing operation of the pressing head becomes shorter, and another one of the plurality of pressing portions on a side of another one of the two stems moves away from the axis extending in the substantially horizontal direction, whereby a depressing stroke of the other one of the plurality of pressing portions on the side of the other one of the two stems in response to the depressing operation of the pressing head becomes longer.

In a preferred embodiment of the present dispensing container configured as above, the plurality of pressing portions of the adjusting member is configured to protrude downward from both end portions of an arm portion extending substantially in the horizontal direction, and the adjusting member is configured to be mounted to the pressing head so as to be rotatable about the axis extending in the substantially vertical direction.

In still another preferred embodiment of the present dispensing container configured as above, the adjusting member includes an operation lever that is orthogonal to a longitudinal direction of the arm portion and that protrudes to a side opposite to the axis extending in the substantially horizontal direction in the plan view, and the operation lever is configured to protrude in the substantially horizontal direction through a through hole provided in the pressing head.

In still another preferred embodiment of the present dispensing container configured as above, the adjusting member is configured to be coupled to a tab provided on an upper surface of the pressing head, so that rotation of the adjusting member is adjustable by rotating the tab.

In still another preferred embodiment of the present dispensing container configured as above, two nozzle portions are respectively mounted to the two stems, the two nozzle portions being configured to respectively guide the two kinds of contents pumped from the two pumps to two dispensing ports, and the adjusting member is configured to press the two stems via the nozzle portions.

In still another preferred embodiment of the present dispensing container configured as above, each of the two the nozzle portions is configured to be provided, in an upper end portion thereof on a side adjacent to the axis extending in the substantially horizontal direction in the plan view, with a recess that is recessed downward.

In still another preferred embodiment of the present dispensing container configured as above, each of the two nozzle portions is configured to be coupled to the corresponding dispensing port via a flexible tube.

### Advantageous Effect

According to the present disclosure, a dispensing container that is capable of changing the ratio between the amounts of two kinds of contents to be dispensed can be provided.

### BRIEF DESCRIPTION OF THE DRAWINGS

In the accompanying drawings:

FIG. 1 is a front sectional view illustrating a dispensing container according to a first embodiment of the present disclosure;

FIG. 2 is an enlarged sectional view illustrating a main part of the dispensing container of FIG. 1;

FIG. 3 is a front view illustrating the dispensing container of FIG. 1;

FIG. 4 is a plan view illustrating the dispensing container of FIG. 1;

FIG. 5 is a plan sectional view illustrating the dispensing container of FIG. 1;

FIG. 6A is a perspective view illustrating an adjusting member constituting the dispensing container according to the first embodiment of the present disclosure as seen from a first direction;

FIG. 6B is a perspective view illustrating the adjusting member constituting the dispensing container according to the first embodiment of the present disclosure as seen from a second direction;

FIG. 7A is a perspective view illustrating a pressing head constituting the dispensing container according to the first embodiment of the present disclosure as seen from the first direction;

FIG. 7B is a perspective view illustrating the pressing head constituting the dispensing container according to the first embodiment of the present disclosure as seen from the second direction;

FIG. 8 is a right side sectional view illustrating the dispensing container of FIG. 1;

FIG. 9 is a plan sectional view illustrating a state in which only one of content liquids can be dispensed as a result of rotation of the adjusting member in FIG. 5;

FIG. 10 is a right side sectional view illustrating a state in which only one of the content liquids can be dispensed as a result of rotation of the adjusting member in FIG. 8;

FIG. 11 is a rear view illustrating the dispensing container of FIG. 1;

FIG. 12 is a front sectional view illustrating a dispensing container according to a second embodiment of the present disclosure;

FIG. 13A is a plan view illustrating the dispensing container of FIG. 12;

FIG. 13B is a plan view illustrating the dispensing container of FIG. 12;

FIG. 14 is a right side sectional view illustrating the dispensing container of FIG. 12;

FIG. 15 is a front view illustrating the dispensing container of FIG. 12;

FIG. 16 is a plan view illustrating a state in which only one of content liquids can be dispensed as a result of rotation of an adjusting member (tab) in FIG. 13B;

FIG. 17A is a right side sectional view illustrating the dispensing container in the state of FIG. 16 (from the side of container A);

FIG. 17B is a right side sectional view illustrating the dispensing container in the state of FIG. 16 (from the side of container B);

FIG. 18 is a plan view illustrating a state in which the ratio between two kinds of content liquids to be dispensed has been changed as a result of rotation of the adjusting member (tab) in FIG. 13B;

FIG. 19A is a right side sectional view illustrating the dispensing container in the state of FIG. 18 (from the side of container A);

FIG. 19B is a right side sectional view illustrating the dispensing container in the state of FIG. 18 (from the side of container B);

FIG. 20 is a plan view illustrating a state in which the amounts of the two kinds of content liquids to be dispensed have been made substantially equal as a result of rotation of the adjusting member (tab);

FIG. 21A is a right side sectional view illustrating the dispensing container in the state of FIG. 20 (from the side of container A);

FIG. 21B is a right side sectional view illustrating the dispensing container in the state of FIG. 20 (from the side of container B);

FIG. 22 is a front sectional view illustrating a dispensing container according to a third embodiment of the present disclosure;

FIG. 23 is a front view illustrating the dispensing container of FIG. 22;

FIG. 24 is a plan view illustrating the dispensing container of FIG. 22; and

FIG. 25 is a plan view illustrating the dispensing container of FIG. 22 excluding an upper wall of a lid.

### DETAILED DESCRIPTION

Hereinafter, a first embodiment of the present disclosure will be described by illustration in more detail with reference to the drawings.

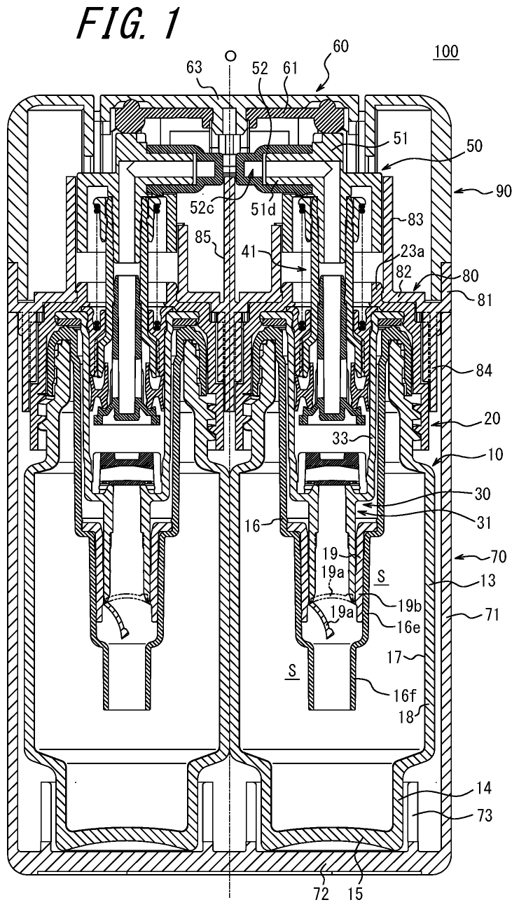

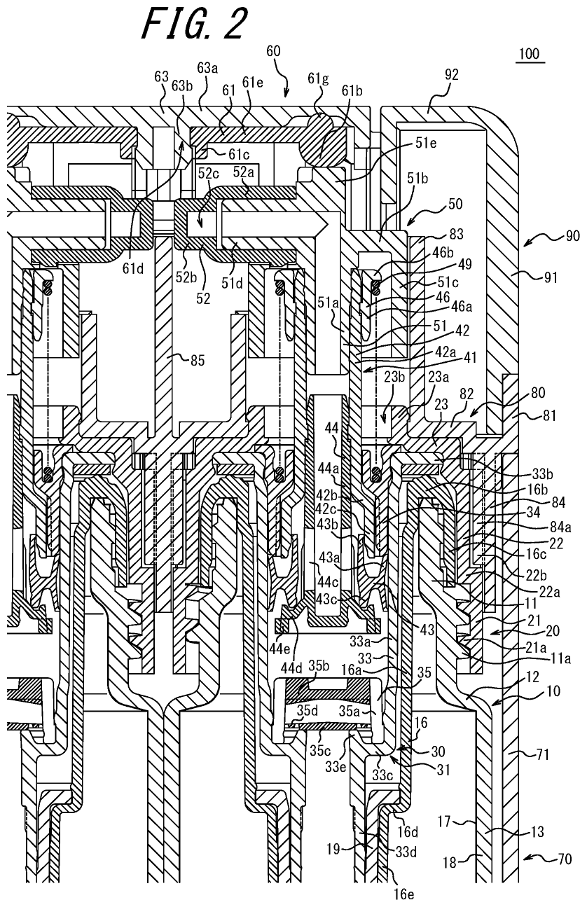

As illustrated in FIG. 1 and FIG. 2, a dispensing container 100 of the present embodiment is used to contain, for example, cosmetic lotions, hair dyes, or the like as contents (content liquids). The dispensing container 100 of the present embodiment includes container bodies 10 that can contain two kinds of contents individually, dispensing caps 20 that are mounted on mouths 11 of the container bodies 10, pumps 30 that pump the contents in the container bodies 10 to dispensing ports 52c, nozzle portions 50 that include the dispensing ports 52c through which the contents are dispensed, a head portion 60 that is configured to operate the pumps 30 in response to a pressing operation, an outer container 70 that covers the two container bodies 10 and the like from the outside, a coupling member 80 that couples the two container bodies 10 and the like, and a lid 90 that covers the nozzle portions 50 and the like.

In the present specification and in the claims, an up/down direction shall mean the up/down direction in a state in which the dispensing container 100 is in an upright position where a pressing head 63 is located on the upper side with respect to the container bodies 10 as illustrated in FIG. 1. Further, a radial direction shall mean the direction that passes through an axis O of the dispensing container 100 and that extends along a straight line perpendicular to the axis O. Moreover, the dispensing container 100 of the present embodiment includes two container bodies 10, two dispensing caps 20, two pumps 30, two nozzle portions 50, or the like, and the dispensing container 100 has a bilaterally symmetrical shape about the axis O in the example of FIG. 1.

The container bodies 10 are also referred to as laminated peelable containers (delamination containers) or double containers. Each container body 10 has a double structure including an outer layer body 18 and an inner layer body 17 accommodated on the inner side of the outer layer body 18, and in response to dispensing of the corresponding content (content liquid), the inner layer body 17 undergoes volume reduction and deformation independently from the outer layer body 18. Further, the container body 10 is provided, in the mouth 11 thereof, with a containing tubular portion 16 as a separate member. The containing tubular portion 16 covers the corresponding pump 30, which will be described later, from the outer side in the radial direction and includes an inner plug member 19.

The outer layer body 18 is a portion constituting an outer shell of the container body 10. As illustrated in FIG. 2, the outer layer body 18 includes the cylindrical-shaped mouth 11, a shoulder 12 that is integral and contiguous with a lower end of the mouth 11 and that has a diameter increasing downward so as to project to the outer side in the radial direction with respect to the mouth 11, a substantially cylindrical-shaped trunk 13 that is integral and contiguous with a lower end of the shoulder 12, a reduced-diameter portion 14 that is provided at a lower end portion of the trunk 13 and that has a diameter reduced toward the inner side in the radial direction than the trunk 13, and a bottom 15 that closes a lower end portion of the reduced-diameter portion 14.

As illustrated in FIG. 1, the inner layer body 17 defines a containing space S for the content.

In the present embodiment, the container body 10 has been formed into a laminated structure in which the inner layer body 17 is laminated in a peelable manner on an inner surface of the outer layer body 18, by co-extruding a synthetic resin material for the outer layer body 18 and a synthetic resin material for the inner layer body 17 that have low compatibility to thereby form a laminated parison and by blow molding the laminated parison with use of a mold. Additionally, the container body 10 may also be formed by biaxially stretch blow molding a preform having a laminated structure that has been formed in advance by injection molding or the like.

In the present embodiment, nylon is used as a material for the inner layer body 17 constituting the container body 10, and polypropylene (PP) is used as a material for the outer layer body 18. The present disclosure, however, is not limited to this embodiment, and an ethylene-vinyl alcohol copolymer resin (EVOH) may also be used as a material for the inner layer body 17, and high-density polyethylene resin (HDPE) or low-density polyethylene (LDPE) may be used as a material for the outer layer body 18. Further, in a case in which a laminated peelable container is formed by biaxial stretched blow molding, for example, polyethylene terephthalate (PET) may be used as a material for the outer layer body 18. It is to be noted that a material for the inner layer body 17 and a material for the outer layer body 18 are not limited to the above-described materials, and other resins having low compatibility with each other can be used as the materials. Further, the container body 10 does not necessarily need to be a laminated peelable container, and the outer layer body 18 and the inner layer body 17 may be formed separately and assembled together. Additionally, although not illustrated, one or more adhesive strips made of, for example, Admer® (Admer is a registered trademark in Japan, other countries, or both) may be disposed between the inner layer body 17 and the outer layer body 18 so that the adhesive strips extending in the up/down direction partially join the inner layer body 17 and the outer layer body 18.

In the present embodiment, the container body 10 is formed by blow molding and is configured so that air can be introduced into a space between the outer layer body 18 and the inner layer body 17 via a slit formed in a pinch-off portion at the bottom 15. When the content is dispensed from the dispensing port 52c, as much air as the amount of the dispensed content is taken into the space between the outer layer body 18 and the inner layer body 17 via the slit from the outside, and, while the inner layer body 17 undergoes volume reduction and deformation, the outer layer body 18 can maintain the original shape. That is, in a case in which the outer layer body 18 is made of a relatively more rigid material, such as polypropylene (PP), high-density polyethylene resin (HDPE), or polyethylene terephthalate (PET), the outer layer body 18 can continue to maintain the same shape regardless of the volume reduction and deformation undergone by the inner layer body 17. Further, in a case in which the outer layer body 18 is made of a relatively less rigid material, such as low-density polyethylene (LDPE), even when the outer layer body 18 temporarily undergoes volume reduction and deformation in conjunction with the volume reduction and deformation undergone by the inner layer body 17, air is subsequently taken into the space between the outer layer body 18 and the inner layer body 17 via the slit, whereby the outer layer body 18 can be restored to the original shape.

Because the above configuration prevents air from being taken into the inner layer body 17 from the outside, it is possible to prevent deterioration of the quality of the content due to oxidation or the like. Further, the content in the inner layer body 17 can be used up as much as possible so as to minimize the remaining amount, and moreover, even contents having high viscosities can be discharged. Besides, even in a case in which only a small amount of the content is discharged as described later, air corresponding to the dispensed amount can be taken into the space between the outer layer body 18 and the inner layer body 17 via the slit.

As illustrated in FIG. 2, the mouth 11 is integrally provided, on an outer circumferential surface thereof, with a male screw portion 11a to which the dispensing cap 20 can be screw-engaged. The male screw portion 11a protrudes to the outer side in the radial direction from the outer circumferential surface of the mouth 11.

Further, the containing tubular portion 16, which includes the inner plug member 19 (refer to FIG. 1) and which covers a lower assembly 31 of the pump 30 from the outer side in the radial direction, is fixed to the mouth 11.

As illustrated in FIG. 2, the containing tubular portion 16 has a tubular-shaped portion 16a that covers the cylinder 33 from the outer side in the radial direction, a flange portion 16b that is contiguous with an upper end portion of the tubular-shaped portion 16a and that protrudes to the outer side in the radial direction, an upper outer wall 16c that hangs down from an outer end of the flange portion 16b, a first reduced-diameter portion 16e that is contiguous with a lower end of the tubular-shaped portion 16a via a stepped portion 16d and that has a diameter smaller than that of the tubular-shaped portion 16a, and a second reduced-diameter portion 16f (refer to FIG. 1) that is contiguous with a lower end of the first reduced-diameter portion 16e and that has a diameter even smaller than that of the first reduced-diameter portion 16e.

The containing tubular portion 16 is positioned and fixed relative to the container body 10, with the upper end portion of the tubular-shaped portion 16a being fitted to an inner circumferential surface of the mouth 11 of the container body 10, thereby sandwiching the mouth 11 between the upper end portion of the tubular-shaped portion 16a and the upper outer wall 16c.

The inner plug member 19 is fitted and fixed to an inner surface of the first reduced-diameter portion 16e, and the inner plug member 19 includes an inner plug 19a for blocking communication between the containing space S of the container body 10 and the outside before assembly of the dispensing container 100 (refer to the inner plug 19a represented by a two-dot chain line in FIG. 1). Then, during assembly of the dispensing container 100, when the cylinder 33 is pushed into the containing tubular portion 16, a lower end portion of a fitting tube 33d presses the inner plug 19a to thereby break up a weakened portion coupling the inner plug 19a and a circumferential wall 19b, whereby the inner plug 19a is displaced to a position indicated by a solid line in FIG. 1, so that communication between the containing space S and the inside of the pump 30 is established. Accordingly, the content in the containing space S becomes ready to be pumped upward by the pump 30 and to be dispensed through the dispensing port 52c in response to the pressing head 63 being depressed.

Next, configurations of the dispensing caps 20 will be described with reference to FIG. 2.

Each dispensing cap 20 is made of polypropylene, and as illustrated in FIG. 2, the dispensing cap 20 is formed in a substantially topped cylindrical shape including an outer circumferential wall 21, an upper circumferential wall 22 that is contiguous with an upper end portion of the outer circumferential wall 21 via the stepped portion 22a, and a top wall 23 that closes an upper end portion of the upper circumferential wall 22. The dispensing cap 20 is mounted to the corresponding container body 10 so that the outer circumferential wall 21 and the upper circumferential wall 22 cover the mouth 11 from the outer side in the radial direction and so that the top wall 23 covers the mouth 11 from above. It is to be noted that the dispensing cap 20 may be formed from other resins, such as polyethylene.

The outer circumferential wall 21 is provided, on an inner circumferential surface thereof, with a female screw portion 21a. The female screw portion 21a protrudes to the inner side in the radial direction from the inner circumferential surface of the outer circumferential wall 21 and is configured to be screw-engaged with the male screw portion 11a.

The upper circumferential wall 22 is provided, on an outer circumferential surface thereof, with vertically extending outer circumferential ribs 22b that are disposed intermittently in the circumferential direction. Each outer circumferential rib 22b fits in between adjacent inner ribs 84a formed on an inner circumferential surface of a side wall portion 84 of the later-described coupling member 80, so as to be coupled with the coupling member 80 in a manner such that the coupling member 80 is prevented from rotating in the circumferential direction.

A fitting tube 23a is formed in a middle portion of the top wall 23 of the dispensing cap 20, and a communication hole 23b, which allows for vertical communication through the top wall 23, is provided on the inner side of the fitting tube 23a. As illustrated in FIG. 2, a stem 42 and a piston guide 44, which constitute an upper assembly 41 of the later-described pump 30, extend vertically through the communication hole 23b, so as to convey pressing force from the head portion 60 to the pump 30.

Next, configurations of the pumps 30 will be described with reference to FIG. 2. Each pump 30 of the present embodiment includes the lower assembly 31, which is fixed to the corresponding container body 10, and the upper assembly 41, which is configured to be movable in the up/down direction with respect to the lower assembly 31, so that the upper assembly 41 can be urged upward by an urging spring 49 and can be moved downward in response to pressing force from the head portion 60 to thereby pump the content in the cylinder 33.

As illustrated in FIG. 2, the lower assembly 31 of the pump 30 includes a cylinder 33 that stores the content from the corresponding containing space S, a second locking member 34 that fits to an inner circumferential surface of an upper end portion of the tubular-shaped portion 33a in the cylinder 33 so as to hold a lower end portion of the urging spring 49, and a draw valve member 35 that has a draw valve 35c and that is fitted in the inner circumferential surface of the cylinder 33.

The cylinder 33 includes a tubular-shaped portion 33a that stores therein the content in a state in which the upper assembly 41 is urged upward, a flange portion 33b that is provided at the upper end portion of the tubular-shaped portion 33a and that is sandwiched between the top wall 23 of the dispensing cap 20 and the mouth 11, a fitting tube 33d that is integrally formed at a lower end portion of the tubular-shaped portion 33a via a stepped portion 33c and that is fitted to an inner circumferential surface of a later-described blocking member 36, and a draw valve seat 33e that protrudes upward from an upper end portion of the fitting tube 33d and that allows the draw valve 35c to be seated thereon for closing the valve.

The draw valve member 35 includes a draw valve 35c that is elastically supported by a support member 35d, support frames 35a in which the draw valve 35c is supported, and an upper wall 35b that closes upper ends of the support frames 35a. The support frames 35a are intermittently formed in the circumferential direction, and when the draw valve 35c is displaced upward in response to a negative pressure in the cylinder 33 so that the valve is opened, the content in the containing space S passes through the inside of the fitting tube 33d, through a space between the draw valve 35c and the draw valve seat 33e, and through spaces between adjacent intermittently formed support frames 35a, thus flowing into the tubular-shaped portion 33a of the cylinder 33.

As illustrated in FIG. 2, the upper assembly 41 of the pump 30 includes a tubular-shaped stem 42 that conveys pressing force from the pressing head 63, a first locking member 46 that holds an upper end portion of the urging spring 49 by an outer circumferential surface of an upper end portion of the stem 42 being fitted thereto, a piston guide 44 that includes a guide body 44a fitted to an inner circumferential surface of the stem 42 and that also includes a discharge valve hole 44c and a discharge valve seat 44d, and an annular piston 43 that vertically moves by sliding on the inner circumferential surface of the tubular-shaped portion 33a of the cylinder 33.

The stem 42 includes a coupling tubular portion 42a that defines a moving space for the content and that has the upper end portion to which the corresponding nozzle portion 50 is fitted, and a large-diameter portion 42c that is contiguous with a lower end portion of the coupling tubular portion 42a via a stepped portion 42b and that has a diameter greater than that of the coupling tubular portion 42a. The piston guide 44 is fitted on the inner side of the coupling tubular portion 42a, and the upper end portion of the coupling tubular portion 42a is fitted to the first locking member 46 holding the upper end portion of the urging spring 49. Further, an inner wall upper end portion 43b of the annular piston 43 is configured to be slidable on an inner circumferential surface of the large-diameter portion 42c. The annular piston 43 has an inner wall lower end portion 43c, which, together with the discharge valve seat 44d, forms a discharge valve. That is, when the inner wall lower end portion 43c is seated on the discharge valve seat 44d, the discharge valve is closed, and when the inner wall lower end portion 43c is spaced from the discharge valve seat 44d, the discharge valve is opened so that the content can pass through the discharge valve hole 44c. Additionally, the annular piston 43 has an outer wall 43a that slides on the inner surface of the tubular-shaped portion 33a of the cylinder 33.

Next, the nozzle portions 50 will be described. Each nozzle portion 50 includes a mounting member 51 that is fitted to the upper end portion of the corresponding stem 42 and that guides the content pumped from the corresponding pump 30 to the dispensing port 52c, and a dispensing port member 52 that is mounted to a tip of the mounting member 51 and that has the dispensing port 52c for the content.

The mounting member 51 includes a perpendicular tubular portion 51a that defines a flow path through which the content is guided upward and that is fitted to the upper end portion of the stem 42, a horizontal tubular portion 51d that is perpendicular to the perpendicular tubular portion 51a and that guides the content to the dispensing port 52c in a horizontal direction, a ceiling wall 51b that is contiguous with an upper end portion of the perpendicular tubular portion 51a, and a circumferential wall 51c that hangs from an outer peripheral edge of the ceiling wall 51b, and a pressure-receiving portion 51e that is provided above the perpendicular tubular portion 51a and that abuts against a pressing portion 61b of a later-described adjusting member 61. In front views illustrated in FIG. 1 and FIG. 2, two horizontal tubular portions 51d are directed from both left and right sides toward the middle. Accordingly, the two kinds of contents pumped from the two container bodies 10 are guided to the middle and dispensed forward (in a direction from the back toward the front perpendicularly to the plane of paper in each of FIG. 1 and FIG. 2) through the two adjacent dispensing ports 52c.

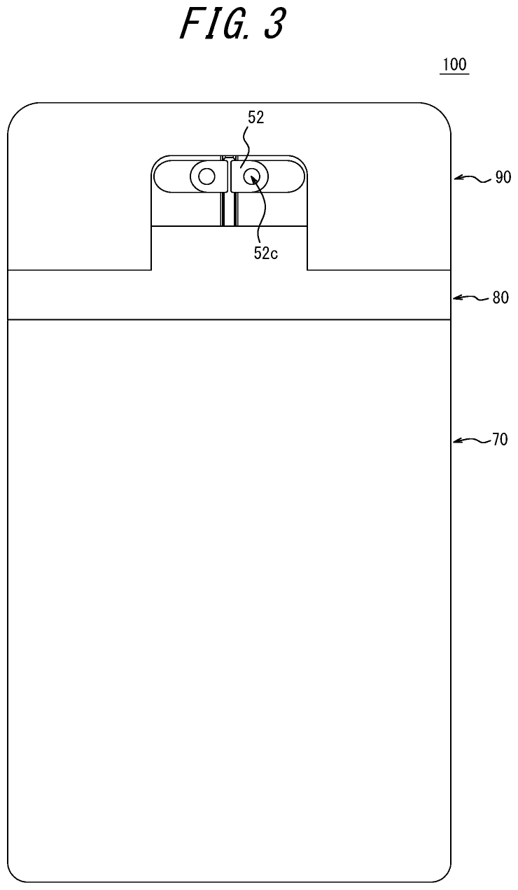

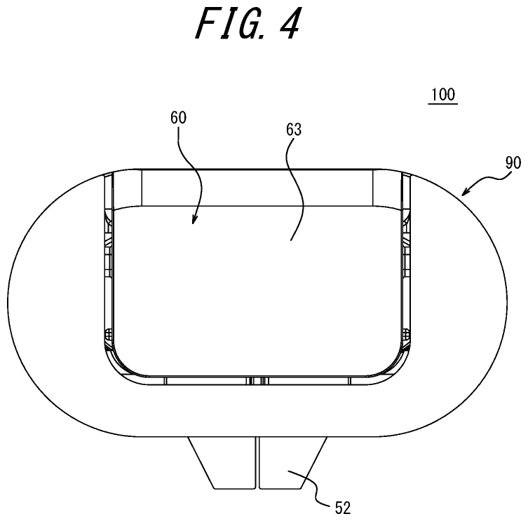

The dispensing port member 52 includes a fitting tubular portion 52a to which an outer circumferential surface of the horizontal tubular portion 51d is fitted, and a dispensing port tubular portion 52b through which the content is guided forward after passing through the horizontal tubular portion 51d. Further, the dispensing port 52c is provided in the dispensing port tubular portion 52b. It is to be noted that a front view and a plan view for the dispensing container 100 including the dispensing port member 52 are respectively illustrated in FIG. 3 and FIG. 4.

Next, the head portion 60 will be described. The head portion 60 includes the adjusting member 61 that depresses the respective pressure-receiving portions 51e of the two mounting members 51 at a stroke ratio desired by the user, and the pressing head 63 through which pressing force is applied to the adjusting member 61.

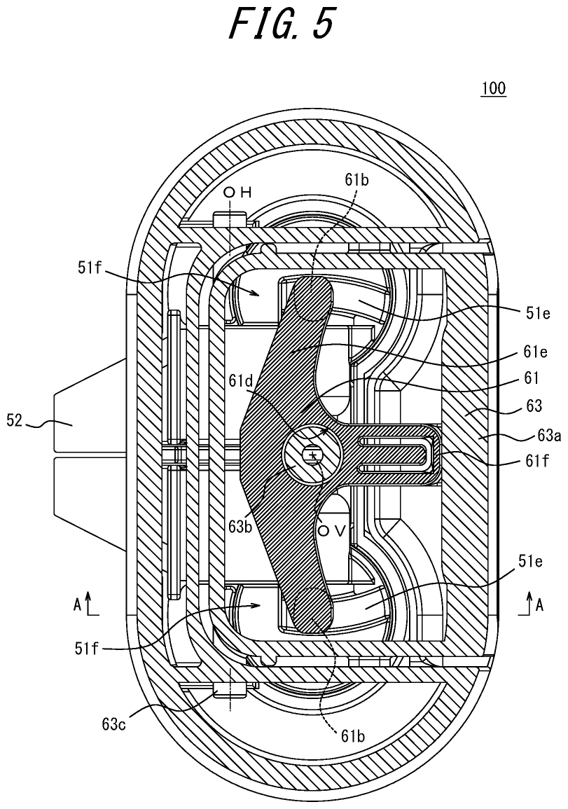

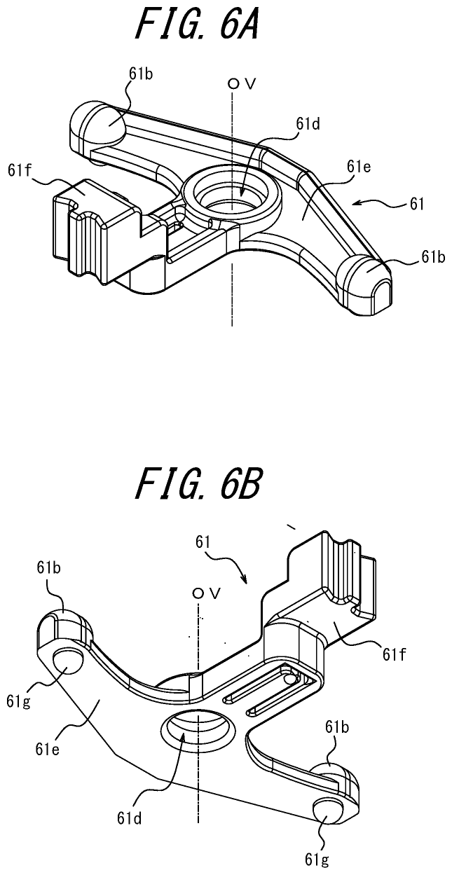

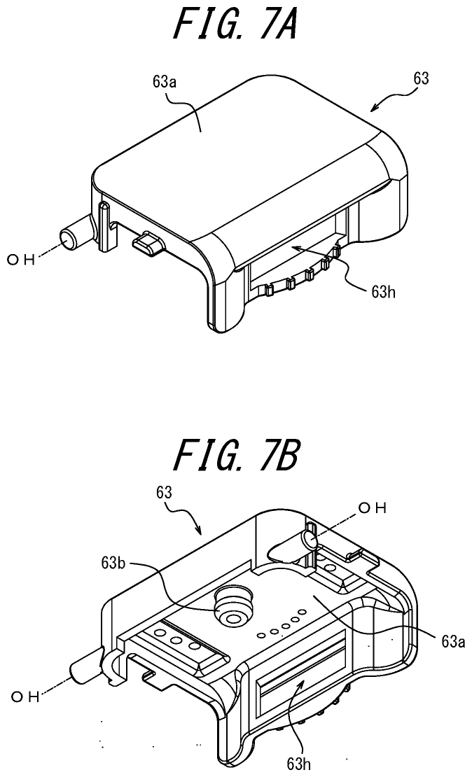

As illustrated in FIG. 5, FIG. 6A, and FIG. 6B, the adjusting member 61 includes an arm portion 61e that extends in a left/right direction (left/right direction in each of FIG. 1 and FIG. 2, which corresponds to the up/down direction of FIG. 5), the pressing portions 61b that are formed on lower surfaces of both end portions in the longitudinal direction of the arm portion 61e, and an operation lever 61f that is orthogonal to the longitudinal direction of the arm portion 61e and that protrudes to a side opposite to an axis OH extending in a substantially horizontal direction illustrated in FIG. 5. The adjusting member 61 is mounted to the pressing head 63 by fitting a rotation shaft 63b (refer to FIG. 5 and FIG. 7B), which is provided in the pressing head 63 to a rotation hole 61d provided in the adjusting member 61, and the adjusting member 61 is rotatable about the rotation shaft 63b (axis OV extending in a substantially vertical direction).

As illustrated in FIG. 5, the pressure-receiving portions 51e of the mounting members 51 are each provided in a shape along a trajectory of the corresponding pressing portion 61b when the adjusting member 61 is rotated about the axis OV extending in the substantially vertical direction. Further, as illustrated in FIG. 5, the pressure-receiving portions 51e are provided, in portions thereof on a side adjacent to an axis (axis OH extending in the substantially horizontal direction) serving as the rotation center of the pressing head 63 when the pressing head 63 is depressed downward, with recesses 51f that are recessed downward relative to the height of the pressure-receiving portions 51e. In the example of FIG. 5, the recesses 51f having a height equal to the height of an upper surface of the ceiling walls 51b are provided in the portions of the pressure-receiving portions 51e that are located on the side adjacent to the axis OH extending in the substantially horizontal direction.

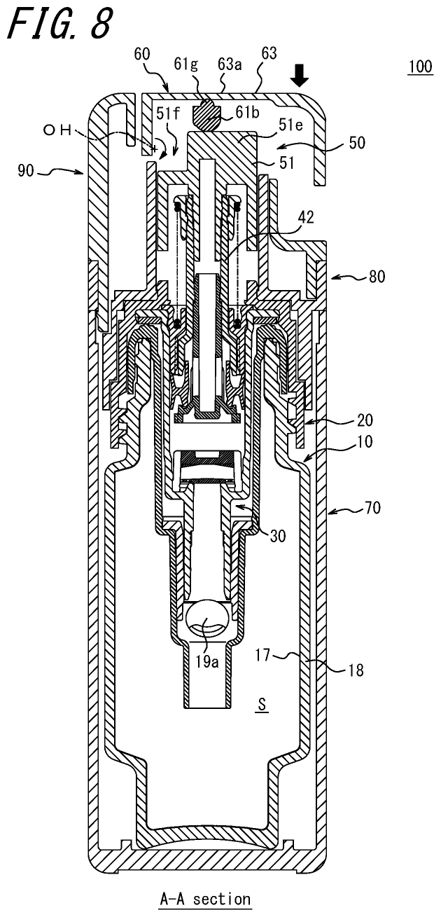

A rotation shaft 63c of the pressing head 63 is configured to be rotatable around a rotation groove (which is not illustrated) provided in the coupling member 80. Thus, when the pressing head 63 is depressed in the arrow direction illustrated in FIG. 8, the pressing head 63 rotates about the rotation shaft 63c (axis OH extending in the substantially horizontal direction). Accordingly, the greater a distance (distance in the left/right direction in FIG. 5 and FIG. 8) between the rotation shaft 63c (axis OH extending in the substantially horizontal direction) and the pressing portion 61b in the plan view, the greater a stroke of the pressing portion 61b depressed by a pressing plate 63a via an abutment portion 61g becomes, provided that the pressing head 63 is rotated through the same angle (refer to FIG. 5 and FIG. 8). A stroke of the corresponding stem 42 depressed by the pressing portion 61b becomes greater accordingly. It is therefore possible to relatively increase the amount of the content to be dispensed by the stem 42 (pump 30) depressed by one of the pressing portions 61b that is at a greater distance from the axis OH extending in the substantially horizontal direction, by rotating the adjusting member 61 about the axis OV extending in the substantially vertical direction to thereby make respective distances (distances in the left/right direction in FIG. 5 and FIG. 8) from the axis OH extending in the substantially horizontal direction to the two pressing portions 61b different from each other in FIG. 5. Thus, the ratio between the two kinds of contents to be dispensed can be changed.

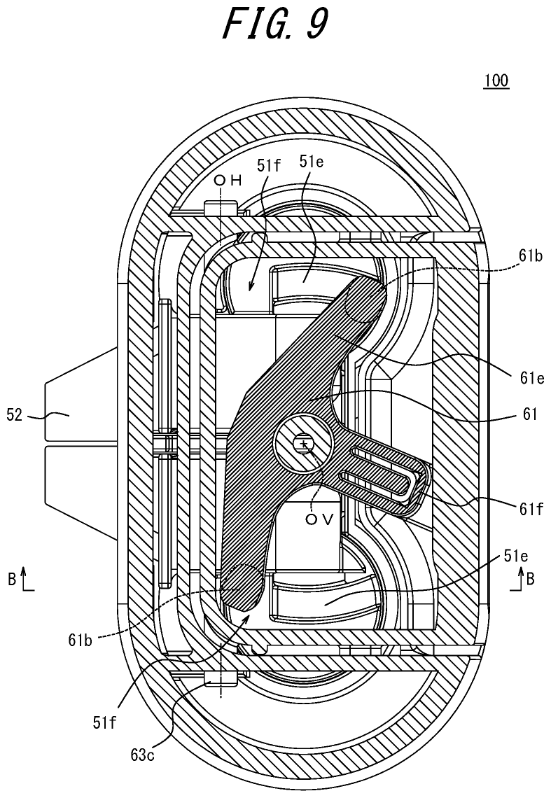

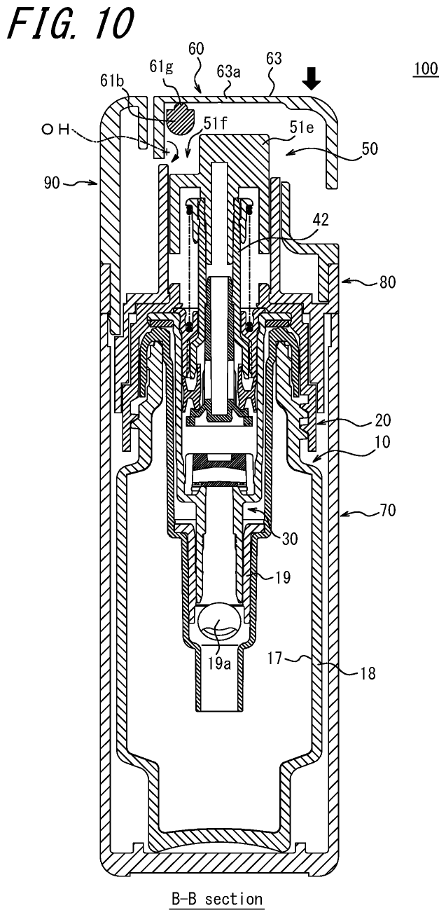

In particular, when one of the pressing portions 61b is above the recess 51f as illustrated in FIG. 9 and FIG. 10, even when the pressing head 63 is depressed, the pressing portion 61b above the recess 51f is not able to press the corresponding mounting member 51, and therefore, one of the pumps 30 whose corresponding pressing portion 61b is above the recess 51f does not operate. This means that only the other pump 30 can operate, and so only one of the two kinds of contents can be dispensed in a selectable manner.

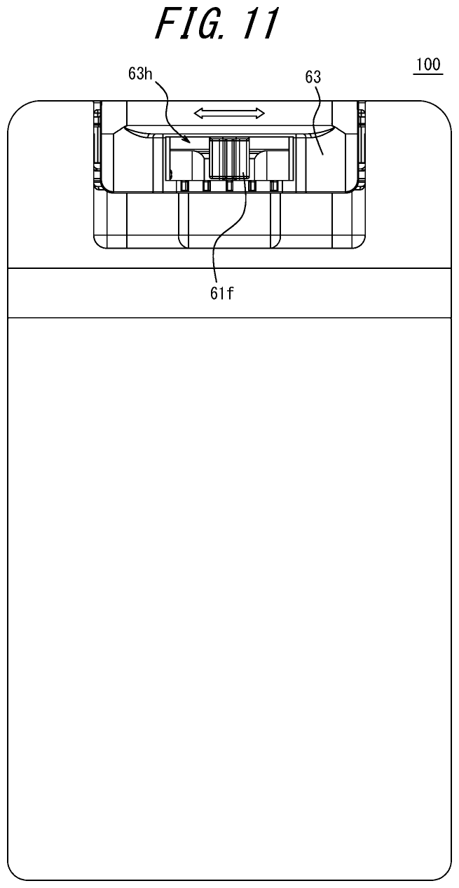

As illustrated in FIG. 11, rotation of the adjusting member 61 can be adjusted by rotating the adjusting member 61 about the axis OV extending in the substantially vertical direction by pinching the operation lever 61f provided in the adjusting member 61 and moving the operation lever 61f in the left/right direction indicated by the arrow. In the illustrated example, because the operation lever 61f protrudes in the horizontal direction by passing through a through hole 63h (refer to FIG. 7A and FIG. 7B) provided in the pressing head 63, the operation lever 61f can be pinched easily, and operation of the adjusting member 61 is simplified.

The outer container 70 has an enough size to accommodate the two container bodies 10, and the outer container 70 includes a side wall portion 71 and a bottom portion 72 closing a lower end of the side wall portion 71. The bottom portion 72 is provided with two positioning walls 73 for accommodating and positioning the reduced-diameter portions 14 of the container bodies 10.

The coupling member 80 for coupling and positioning the two dispensing caps 20 is fitted to an inner circumferential surface of an upper end portion of the outer container 70. The coupling member 80 includes the side wall portion 84 that surrounds the outer circumferential walls 21 of the dispensing caps 20, an upper wall 82 that is contiguous with an upper end portion of the side wall portion 84 and that couples the two dispensing caps 20, a circumferential wall 81 that extends upward from an outer peripheral edge of the upper wall 82, two upper tubular walls 83 that each extend upward from an upper surface of the upper wall 82 and that each surround the corresponding nozzle portion 50 from the outer side in the radial direction, a partition wall 85 that divides the dispensing caps 20, the pumps 30 and the nozzle portions 50 in the middle in the left/right direction. As illustrated in FIG. 1, the dispensing caps 20 are fixed to the coupling member 80 in a manner such that the dispensing caps 20 are prevented from slipping off in the up/down direction, by the fitting cylinders 23a of the dispensing caps 20 being fitted to inner circumferential surfaces of the upper tubular walls 83. Further, the dispensing caps 20 are fixed to the coupling member 80 in a manner such that the dispensing caps 20 are prevented from rotating, by the outer circumferential ribs 22b of the dispensing caps 20 each being fitted in between adjacent inner ribs 84a formed on the inner circumferential surface of the side wall portion 84 of the coupling member 80.

The lid 90 includes an outer circumferential wall 91 that covers the nozzle portions 50 and the head portion 60 from the outer side in the radial direction, and an upper wall 92 that is contiguous with an upper end portion of the outer circumferential wall 91. Further, the lid 90 is fixed to the coupling member 80, by a lower end portion of the outer circumferential wall 91 being fitted to an inner circumferential surface of the circumferential wall 81. The lid 90 covers an area above the coupling member 80 except for an upper surface of the pressing head 63 from the outer side in the radial direction and from above. In the plan view, the outer circumferential wall 91 of the lid 90 is configured to be substantially aligned with the circumferential wall 81 of the coupling member 80 and with the side wall portion 71 of the outer container 70.

To dispense the contents from the dispensing container 100 with the above configuration, the user first depresses the pressing head 63 in an upright state of the dispensing container 100 illustrated in FIG. 1. At this time, the pressing head 63 is rotated about the axis OH extending in the substantially horizontal direction illustrated in FIG. 5 and FIG. 8, thereby depressing each pressing portion 61b with a stroke substantially proportional to a distance in the horizontal direction between the axis OH extending in the substantially horizontal direction and the pressing portion 61b. The user, therefore, can change the stroke of each pressing portion 61b depressing the corresponding stem 42, by rotating the adjusting member 61 about the axis OV extending in the substantially vertical direction in the state illustrated in FIG. 5 and FIG. 8 so as to change the distance in the horizontal direction between the axis OH extending in the substantially horizontal direction and the pressing portion 61b. This allows for dispensing of the two kinds of contents in the respective container bodies 10 corresponding to the stems 42 while changing the ratio between their amounts to be dispensed.

When the stem 42 constituting the upper assembly 41 of each pump 30 is depressed in response to the pressing head 63 being depressed, the piston guide 44, which is fitted and fixed to the inner circumferential surface of the stem 42, also moves downward at the same time. At this time, the inner wall upper end portion 43b of the annular piston 43 is only slightly displaced because the inner wall upper end portion 43b slides against the inner circumferential surface of the large-diameter portion 42c. Accordingly, the discharge valve seat 44d of the piston guide 44 is separated from the inner wall lower end portion 43c of the annular piston 43, whereby the discharge valve is temporarily brought into an open state.

As a result of downward displacement of the lower end portion 44e of the piston guide 44, the content stored in the cylinder 33 is compressed, passes through the opened discharge valve, and flows into the piston guide 44 through the discharge valve hole 44c so as to be pumped upward. Although the stem 42 moves downward by a distance corresponding to a pressing stroke of the pressing portion 61b, the stem 42 stops, at farthest, at a position where the lower end portion 44e of the piston guide 44 comes into abutment against the upper wall 35b of the draw valve member 35. As is apparent from FIG. 2 and the like, the greater the stroke of the stem 42 and the greater the downward displacement of the piston guide 44, the greater the volume of the content to be pumped upward through the discharge valve and the greater the amount of the content that can be dispensed through the dispensing port 52c.

When the user stops depressing the pressing head 63, the first locking member 46 is pushed back upward by restoring force of the urging spring 49. Accordingly, the stem 42, which is fitted to the inner circumferential surface of the first locking member 46, is also pulled upward together with the piston guide 44, thereby causing a negative pressure inside the cylinder 33. Further, because the inner wall lower end portion 43c of the annular piston 43 is not seated on the discharge valve seat 44d immediately after the stem 42 and the piston guide 44 start to be displaced upward, some of the content within a passage leading from an inner space of the piston guide 44 to the dispensing port 52c that corresponds to a change in volume inside the cylinder 33 is drawn downward by the negative pressure. This effect, which is also referred to as a suck back effect, causes the content remaining in the passage to be drawn into the cylinder 33, to thereby prevent liquid-dripping from the dispensing port 52c. As upward displacement of the piston guide 44 further continues, the discharge valve seat 44d abuts against the inner wall lower end portion 43c to be sealed, so that the discharge valve is closed. In conjunction with the closing of the discharge valve, the draw valve 35c of the draw valve member 35 is in turn lifted upward by the aforementioned negative pressure against its own weight and against elastic force of the support member 35d, so that the draw valve 35c is opened. The content in the containing space S is drawn up by the negative pressure inside the cylinder 33, passes through the draw valve 35c, and passes through spaces between adjacent support frames 35a so as to be stored in the cylinder 33.

When the stem 42 reaches the uppermost point in its movable range, the content stops from being drawn from the containing space S into the cylinder 33, and the draw valve 35c is seated on the draw valve seat 33e again. At this time, although the inner layer body 17 undergoes volume reduction and deformation in conjunction with a decrease in the content in the containing space S, since the draw valve 35c is closed, air cannot be taken into the inner layer body 17 from the outside. This prevents deterioration of the quality of the content due to oxidation or the like. Further, since air is introduced into the space between the outer layer body 18 and the inner layer body 17 via the slit formed at the bottom 15 of the container body 10, the outer layer body 18 can maintain the original shape even when the inner layer body 17 undergoes volume reduction and deformation. In particular, by changing the ratio between the amounts of the two kinds of contents to be dispensed, even in a case in which the amount of one of the contents to be dispensed is small, an amount of air corresponding to the small amount dispensed is introduced into the space between the outer layer body 18 and the inner layer body 17 via the slit at the bottom 15. Thus, the outer layer body 18 can easily maintain the original shape.

As described above, a dispensing container of the present embodiment includes: two container bodies 10 configured to respectively contain two kinds of contents; two pumps 30 respectively including two protruding stems 42 configured to be depressed in an upwardly urged state, the two pumps 30 being configured to respectively pump the two kinds of contents in the two container bodies 10 upward in response to the two stems 42 being depressed; an adjusting member 61 configured to directly or indirectly press the two stems 42 and configured to be rotatable about an axis OV extending in a substantially vertical direction that is located between the two container bodies 10 in a plan view; and a pressing head 63 configured to, in response to a depressing operation, rotate about an axis OH extending in a substantially horizontal direction that is parallel to a direction in which the two container bodies 10 are arranged, to thereby depress the two stems 42 via the adjusting member 61, wherein the adjusting member 61 includes a plurality of pressing portions 61b against which the two stems 42 are directly or indirectly pressed, and when the adjusting member 61 is rotated about the axis OV extending in the substantially vertical direction, one of the plurality of pressing portions 61b on a side of one of the two stems approaches the axis OH extending in the substantially horizontal direction in the plan view, whereby a depressing stroke of the one of the plurality of pressing portions 61b on the side of the one of the two stems in response to a depressing operation of the pressing head 63 becomes shorter, and another one of the plurality of pressing portions 61b on a side of another one of the two stems moves away from the axis OH extending in the substantially horizontal direction, whereby a depressing stroke of the other one of the plurality of pressing portions 61b on the side of the other one of the two stems in response to the depressing operation of the pressing head 63 becomes longer. Adopting such a configuration allows for dispensing in which the ratio between the amounts of the two kinds of contents to be dispensed can be changed by adjusting rotation of the adjusting member 61 before depressing the pressing head 63 and dispensing the contents. In particular, because in the present embodiment the ratio between the amounts to be dispensed can be adjusted by adjusting rotation of the adjusting member 61, the two kinds of contents can be dispensed while changing the ratio between the amounts of the two kinds of contents to be dispensed, without having to change relative positions of the container bodies 10 and the dispensing ports 52c.

Further, in the present embodiment, the plurality of pressing portions 61b of the adjusting member 61 is configured to protrude downward from both end portions of an arm portion 61e extending substantially in the horizontal direction, and the adjusting member 61 is configured to be mounted to the pressing head 63 so as to be rotatable about the axis OV extending in the substantially vertical direction. By adopting such a configuration, the adjusting member 61 can be configured to be compact, and moreover, the stems 42 can be reliably depressed by the pressing portions 61b protruding downward to thereby operate the pumps 30.

Further, in the present embodiment, the adjusting member 61 includes an operation lever 61f that is orthogonal to a longitudinal direction of the arm portion 61e and that protrudes to a side opposite to the axis OH extending in the substantially horizontal direction in the plan view, and the operation lever 61f is configured to protrude in the substantially horizontal direction through a through hole 63h provided in the pressing head 63. By adopting such a configuration, rotation of the adjusting member 61, which is disposed between the pressing head 63 and the stems 42, can be easily adjusted by using the operation lever 61f.

Further, in the present embodiment, two nozzle portions 50 are respectively mounted to the two stems 42, and the adjusting member 61 is configured to press the two stems 42 via the nozzle portions 50. The two nozzle portions 50 are configured to respectively guide the two kinds of contents pumped from the two pumps 30 to two dispensing ports 52c. By adopting such a configuration, the stems 42 can be pressed more easily compared with a case in which the adjusting member 61 directly presses the stems 42, and moreover, the contents can be easily guided to the dispensing ports 52c by changing directions of the contents at the nozzle portions 50.

Further, in the present embodiment, each of the two the nozzle portions 50 is configured to be provided, in an upper end portion thereof on the side adjacent to the axis OH extending in the substantially horizontal direction in the plan view, with a recess 51f that is recessed downward. By adopting such a configuration, a state in which one of the two kinds of contents cannot be dispensed may be created without difficulty.

In the following, a dispensing container 200 according to a second embodiment of the present disclosure will be described by illustration in detail with reference to the drawings.

It is to be noted that, compared with the first embodiment, the dispensing container 200 according to the second embodiment is similar to the first embodiment, except for the following points: the functions of the dispensing caps 20 and the coupling member 80 are realized by a dispensing cap 120 alone; the functions of the mounting members 51 and the dispensing port members 52 in the nozzle portions 50 are realized by mounting members 151, dispensing port members 152, and flexible tubes 153 of nozzle portions 150; the functions of the adjusting member 61 and the operation lever 61f of the head portion 60 are realized by an adjusting member 161 and a tab 165 of a head portion 160; and pipes P are fitted inside the second reduced-diameter portions 16f of the containing tubular portions 16. The description herein will therefore focus on the points different from the first embodiment.

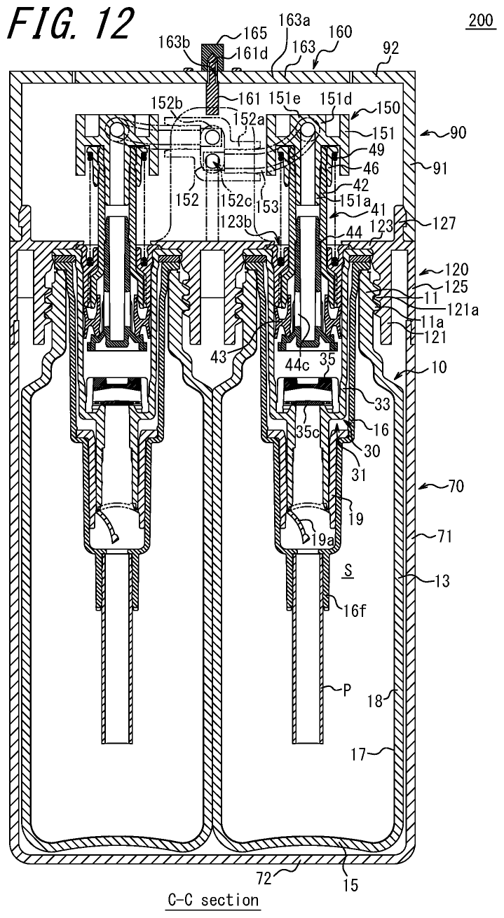

The dispensing cap 120 of the present embodiment is made of polypropylene, and as illustrated in FIG. 12, dispensing cap 120 includes two inner circumferential walls 121 that are respectively mounted to the mouths 11 of the two container bodies 10, an outer circumferential wall 125 that has a rectangular shape with rounded corners in the plan view and that surrounds the two inner circumferential walls 121 from the outer side, a top wall 123 that is contiguous with respective upper end portions of the inner circumferential walls 121 and the outer circumferential wall 125, and an upper circumferential wall 127 that extends further upward from an upper surface of the top wall 123 and that is used to mount the lid 90 thereon by fitting to an inner circumferential surface of a lower end portion of the outer circumferential wall 91 in the lid 90. The dispensing cap 120 is mounted to the container bodies 10 so that the inner circumferential walls 121 cover the mouths 11 from the outer side in the radial direction and that the top wall 123 covers the mouths 11 from above. Additionally, the dispensing cap 120 may be formed from other resins, such as polyethylene.

Each inner circumferential wall 121 is provided, on an inner circumferential surface thereof, with a female screw portion 121a. The female screw portion 121a protrudes to the inner side in the radial direction from the inner circumferential surface of the inner circumferential wall 121, and the female screw portion 121a is configured to be screw-engaged with the male screw portion 11a.

An upper end portion of the side wall portion 71 of the outer container 70 is fitted to an inner circumferential surface of a lower end portion of the outer circumferential wall 125. The outer circumferential wall 125 has a substantially rectangular shape that is substantially aligned with the outer circumferential wall 91 of the lid 90 and the side wall portion 71 of the outer container 70 in the plan view. Thus, the dispensing container 200 has a prismatic outer shape having substantially the same sectional shape in the plan view from the lid 90 to the outer container 70.

The top wall 123 of the dispensing cap 120 is provided with two communication holes 123b. As illustrated in FIG. 12, the stems 42 and the piston guides 44 constituting the upper assemblies 41 of the pumps 30 extend vertically through the communication holes 123b, so as to convey pressing force from the head portion 160 to the pumps 30.

Next, the nozzle portions 150 will be explained. Each nozzle portion 150 includes a mounting member 151 that is fitted to an upper end portion of the corresponding stem 42 and that guides the content pumped from the corresponding pump 30 to a dispensing port 152c, a flexible tube 153 that is mounted to a horizontal tubular portion 151d of the mounting member 151 so as to flexibly couple the mounting member 151 and the dispensing port member 152, and the dispensing port member 152 that is provided with the dispensing port 152c for the content.

The mounting member 151 has a vertical tubular portion 151a that defines a flow path for guiding the content upward and that is fitted to the upper end portion of the stem 42, a horizontal tubular portion 151d that is orthogonal to the vertical tubular portion 151a and that guides the content in the horizontal direction, and a pressure-receiving portion 151e that is provided above the vertical tubular portion 151a so that a pressing portion 161b of a later-described adjusting member 161 abuts against the pressure-receiving portion 151e. The horizontal tubular portion 151d is directed in a direction perpendicular to the plane of the paper in the front view illustrated in FIG. 12.

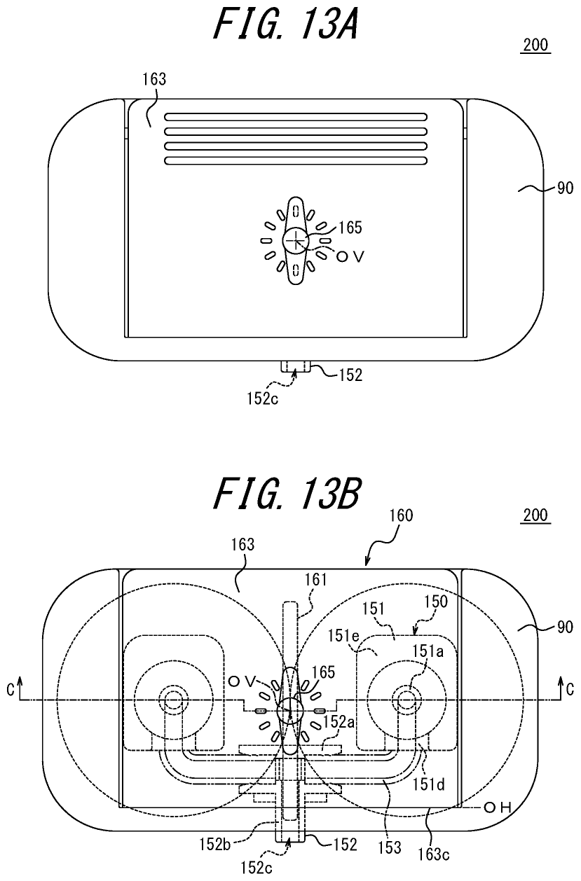

As illustrated in FIG. 12 and FIG. 13B, the horizontal tubular portion 151d is coupled to a fitting tubular portion 152a of the dispensing port member 152 by the flexible tube 153. As illustrated in FIG. 13B, the flexible tube 153 is bent at substantially 90 degrees, to thereby guide the content to flow in from either side in the left/right direction of the dispensing port member 152 after being discharged forward from the horizontal tubular portion 151d.

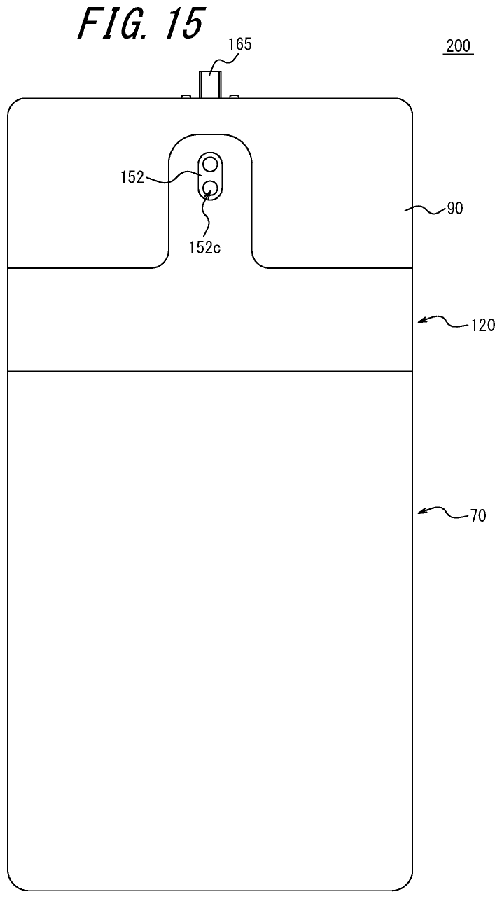

The dispensing port member 152 includes the fitting tubular portion 152a to which an outer circumferential surface of the flexible tube 153 is fitted, and a dispensing port tubular portion 152b through which the content is guided forward. Further, the dispensing port tubular portion 152b is provided, inside thereof, with a dispensing port 152c. It is to be noted that a plan view and a front view of the dispensing container 200 including the dispensing port member 152 are illustrated in FIG. 13A and FIG. 15.

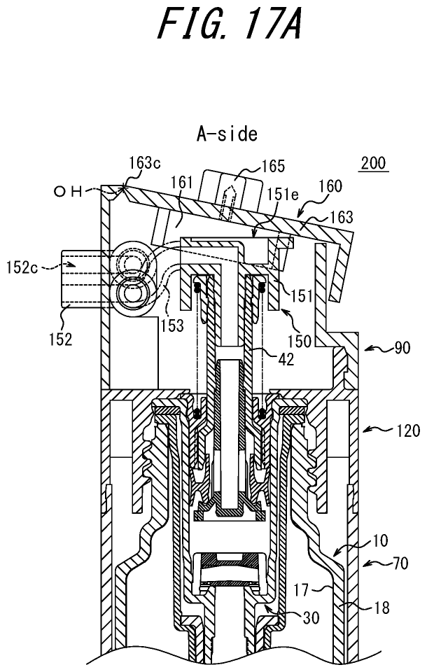

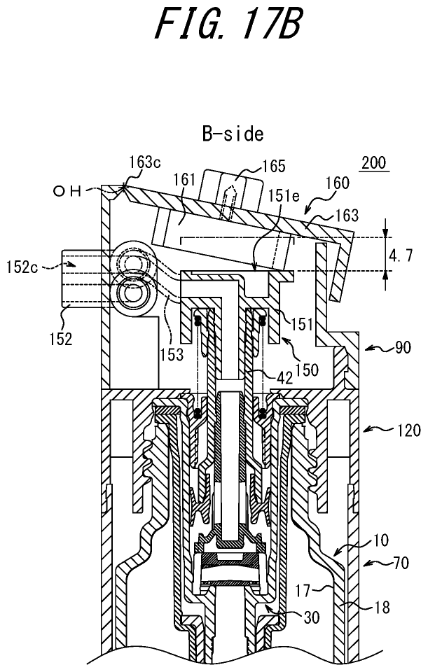

By thus coupling the mounting member 151 and the dispensing port member 152 via the flexible tube 153, the flexible tube 153 can absorb relative height fluctuations between the mounting member 151 and the dispensing port member 152, so that the dispensing port member 152 can be maintained at the same position without tilting, even when, for example, the mounting member 151 is significantly displaced downward in response to a pressing head 163 being depressed as illustrated in FIG. 17B which will be described later.

Next, the head portion 160 will be described. The head portion 160 includes the adjusting member 161 that depresses the respective pressure-receiving portions 151e of the two mounting members 151 at a stroke ratio desired by the user, and the pressing head 163 through which pressing force is applied to the adjusting member 161.

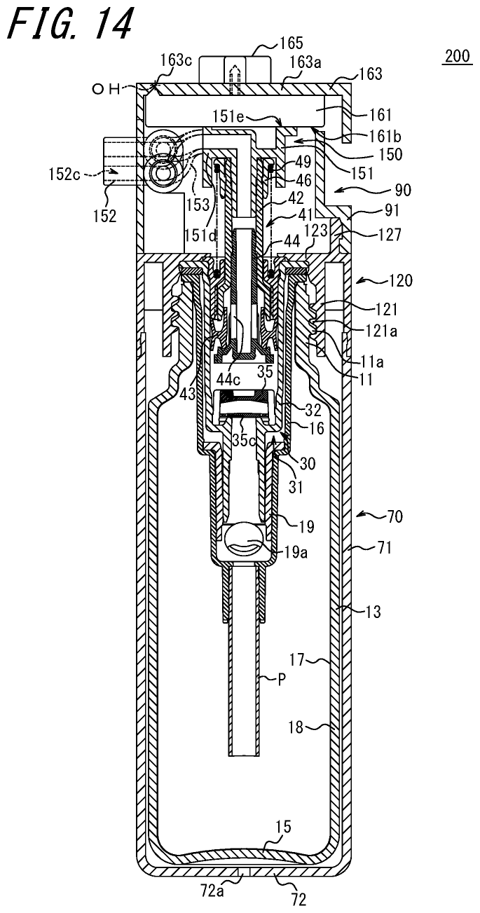

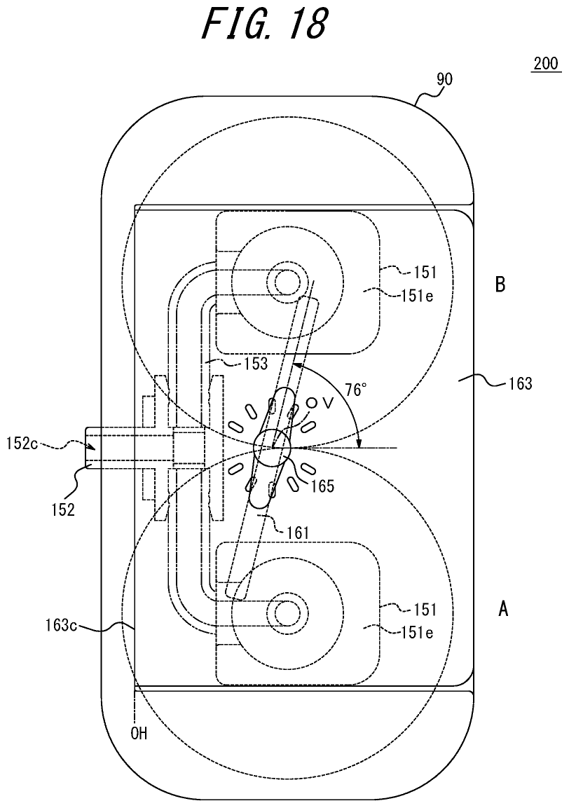

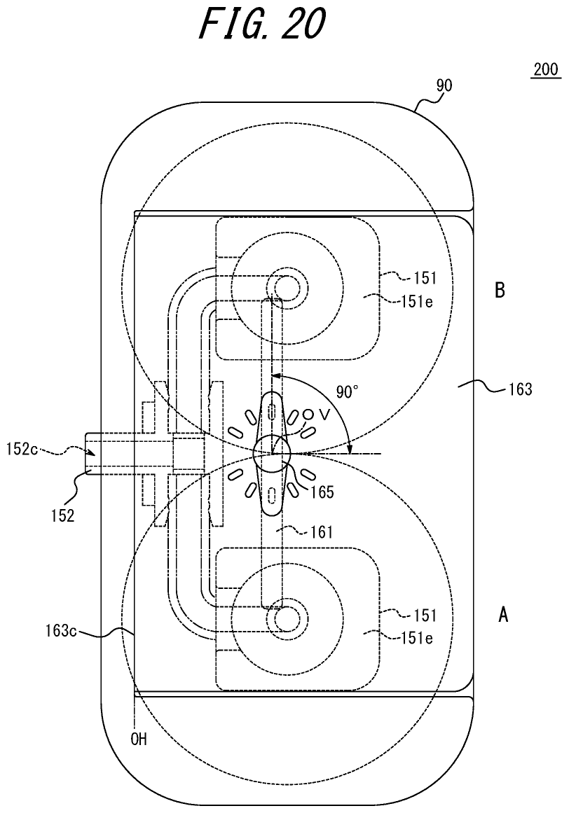

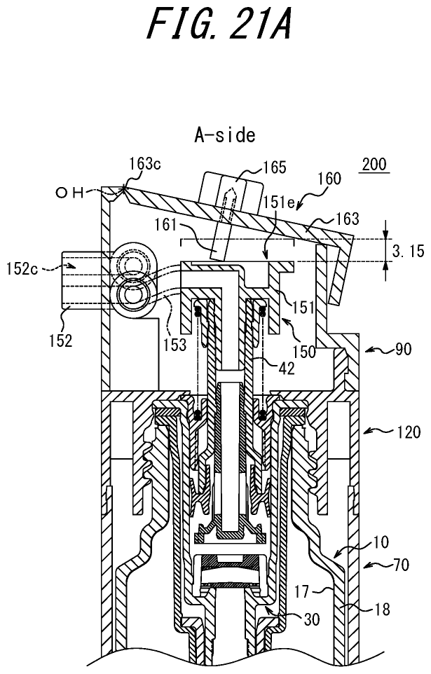

As illustrated in FIG. 13B and FIG. 14, the adjusting member 161 has a prismatic shape with a lower surface constituting pressing portions 161b. The adjusting member 161 includes a rotation shaft 161d that protrudes upward from its upper surface at the middle in its longitudinal direction, and the rotation shaft 161d protrudes upward through a rotation hole 163b formed in a pressing plate 163a of the pressing head 163 (refer to FIG. 12). The rotation shaft 161d is fitted to the tab 165 on an upper surface of the pressing plate 163a, and the adjusting member 161 is rotatable about the rotation shaft 161d (axis OV extending in the substantially vertical direction) by rotating the tab 165 in the circumferential direction. In the present embodiment, as illustrated in FIG. 18 and FIG. 20 which will be described later, the adjusting member 161 is configured to press the mounting member 151 at both two ends in the longitudinal direction of its lower surface. In this sense, the adjusting member 161 includes two pressing portions 161b.

As illustrated in FIG. 14, the pressing head 163 is integrally formed with the lid 90 and is configured to be rotatable about a hinge portion 163c. Thus, when the pressing plate 163a of the pressing head 163 is depressed, the pressing head 163 rotates about the hinge portion 163c (axis OH extending in the substantially horizontal direction). Accordingly, the greater a horizontal distance (distance in the left/right direction in FIG. 14) between a portion of a pressing portion 161b on the lower surface of the adjusting member 161 that actually presses the pressure-receiving portion 151e of the corresponding mounting member 151, the greater a stroke of the pressing portion 161b depressed by the pressing plate 163a becomes, provided that the pressing head 163 is rotated through the same angle. A stroke of the corresponding stem 42 depressed by the pressing portion 161b becomes greater accordingly. It is to be noted that FIG. 12 to FIG. 15 illustrate locked states in which, even when the pressing head 163 is depressed, the pressing head 163 and the adjusting member 161 do not come into abutment, thereby not depressing the stems 42.

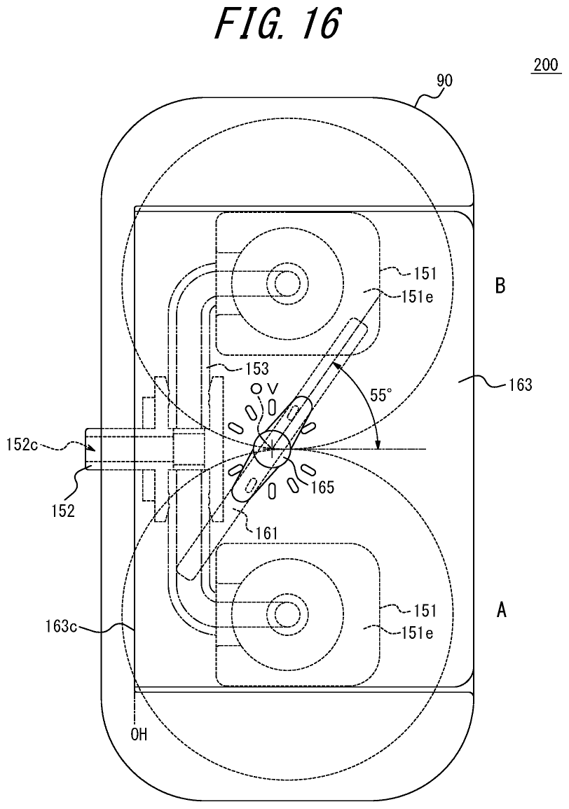

FIG. 16 illustrates a state in which the tab 165 has been rotated counterclockwise by 55 degrees in the plan view from the locked state illustrated in FIG. 13B. As a result of the adjusting member 161 also being rotated in conjunction with the rotation of the tab 165, the adjusting member 161 and the mounting member 151 do not overlap at all on a side of container A located below in FIG. 16. On the other hand, on a side of container B located above in FIG. 16, the adjusting member 161 and the mounting member 151 are overlapped in the plan view and are therefore in a state in which the mounting member 151 can be pressed in response to pressing of the pressing head 163.

FIG. 17A and FIG. 17B are right side sectional views each illustrating the dispensing container 200 in the state of FIG. 16. FIG. 17A is a sectional view from the side of container A, illustrating that even when the pressing head 163 is pressed and rotated about the hinge portion 163c (axis OH extending in the substantially horizontal direction), the adjusting member 161 does not overlap with the mounting member 151 in the plan view, so that the mounting member 151 cannot pressed. It is therefore not possible to dispense the content on the side of container A. On the other hand, on the side of container B illustrated in FIG. 17B, when the pressing head 163 is pressed and rotated about the hinge portion 163c (axis OH extending in the substantially horizontal direction), the pressing portion 161b of the adjusting member 161 presses the mounting member 151, so that the stem 42 on the side of container B is also pressed. The content is therefore dispensed on the side of container B. Thus, when the adjusting member 161 is at the position illustrated in FIG. 16, FIG. 17A, and FIG. 17B, the ratio between the amounts of contents to be dispensed can be set to 0:100.

FIG. 18 illustrates a state in which the tab 165 has been rotated counterclockwise by 76 degrees in the plan view from the locked state illustrated in FIG. 13B. As a result of the adjusting member 161 also being rotated in conjunction with the rotation of the tab 165, the adjusting member 161 and the respective mounting members 151 are overlapped in the plan view both on the side of container A located below in FIG. 18 and on the side of container B located above in FIG. 18, thus being in a state in which both the mounting members 151 can be pressed in response to pressing of the pressing head 163.

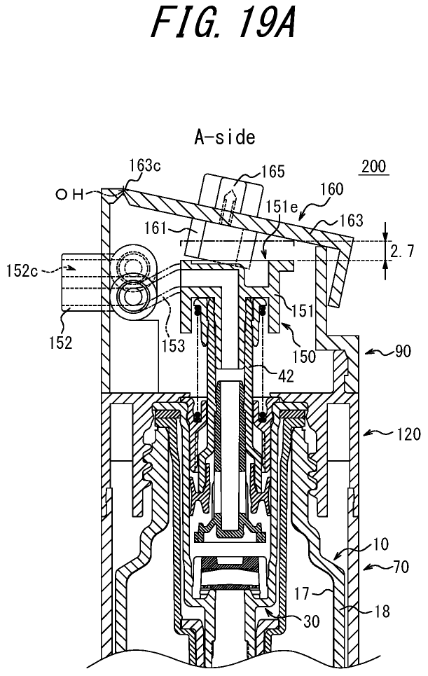

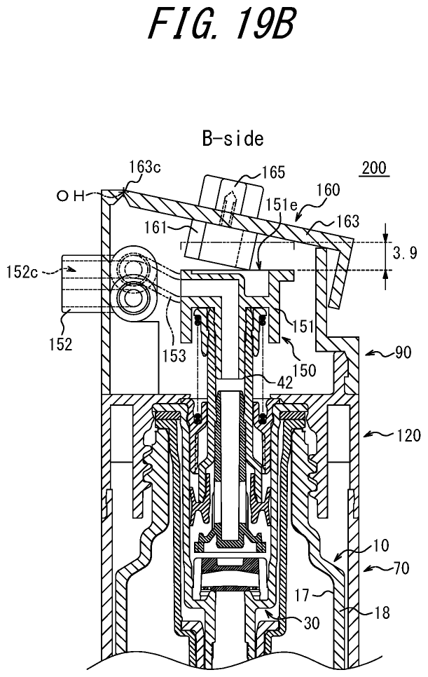

As can be understood from FIG. 18, however, a distance from the hinge portion 163c (axis OH extending in the substantially horizontal direction) to a portion of the pressing portion 161b of the adjusting member 161 that overlaps with the pressure-receiving portion 151e of the mounting member 151 on the side of container A is smaller than that from the hinge portion 163c to a portion of the pressing portion 161b of the adjusting member 161 that overlaps with the pressure-receiving portion 151e of the mounting member 151 on the side of container B. Accordingly, when the pressing head 163 is pressed and rotated about the hinge portion 163c (axis OH extending in the substantially horizontal direction), a stroke length of the pressing head 163 pressing the mounting member 151 via the adjusting member 161 on the side of container A is 2.7 mm, and a stroke length of that on the side of container B is 3.9 mm. Thus, as can be understood from a comparison between FIG. 19A and FIG. 19B, the stroke length on the side of container A is smaller. Thus, the degree to which the stem 42 on the side of container A is depressed can be reduced compared with the degree to which the stem 42 on the side of container B is depressed, and therefore, the amount of the content to be dispensed on the side of container A can be reduced compared with the amount of the content to be dispensed on the side of container B. Additionally, the present applicants have conducted studies and found that the amount dispensed on the side of container A: the amount dispensed on the side of container B=30:70.

FIG. 20 illustrates a state in which the tab 165 has been rotated counterclockwise by 90 degrees in the plan view from the locked state illustrated in FIG. 13B. As a result of the adjusting member 161 also being rotated in conjunction with the rotation of the tab 165, the adjusting member 161 and the respective mounting members 151 are overlapped in the plan view by the same area both on the side of container A located below in FIG. 20 and on the side of container B located above in FIG. 20, thus being in a state in which both the mounting members 151 can be pressed in response to pressing of the pressing head 163.

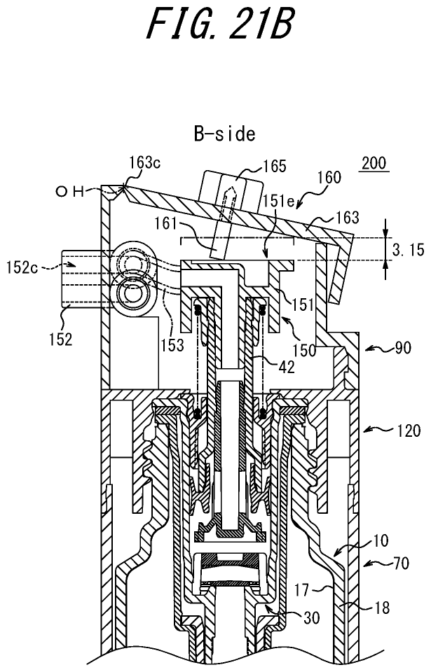

Moreover, a distance from the hinge portion 163c (axis OH extending in the substantially horizontal direction) to a portion of the pressing portion 161b of the adjusting member 161 on the side of container A that overlaps with the pressure-receiving portion 151e of the mounting member 151 is the same as that from the hinge portion 163c to a portion of the pressing portion 161b of the adjusting member 161 on the side of container B that overlaps with the pressure-receiving portion 151e of the mounting member 151. Accordingly, when the pressing head 163 is pressed and rotated about the hinge portion 163c (axis OH extending in the substantially horizontal direction), a stroke length of the pressing head 163 pressing the mounting member 151 via the adjusting member 161 on the side of container A is 3.15 mm, and a stroke length of that on the side of container B is equally 3.15 mm, as can be understood from a comparison between FIG. 21A and FIG. 21B. Thus, the degree of pressing of the stem 42 on the side of container A can be made substantially equal to the degree of pressing of the stem 42 on the side of container B, and therefore, the amount of the content to be dispensed on the side of container A can be made substantially equal to the amount of the content to be dispensed on the side of container B.

As described above, in the present embodiment, the adjusting member 161 is configured to be coupled to the tab 165, which is provided on the upper surface of the pressing head 163, so that rotation of the adjusting member 161 can be adjusted by rotating the tab 165. By adopting such a configuration, the adjusting member 161, which is disposed between the pressing head 163 and the mounting members 151, can be adjusted by a simple operation of rotating the tab 165 provided on the pressing head 163.

Further, in the present embodiment, each nozzle portion 150 is configured to be coupled to the corresponding dispensing port 152c via the corresponding flexible tube 153. By adopting such a configuration, the flexible tube 153 can absorb relative height fluctuations between the mounting member 151 and the dispensing port 152c (dispensing port member 152), so that the dispensing port 152c can be maintained at the same position without tilting, even when the nozzle portion 150 (mounting member 151) is significantly displaced downward in response to the pressing head 163 being depressed.

In the following, a dispensing container 300 according to a third embodiment of the present disclosure will be described by illustration in detail with reference to the drawings.

It is to be noted that, compared with the first embodiment, the dispensing container 300 according to the third embodiment is similar to the first embodiment, except for the following points: the functions of the dispensing caps 20 and the coupling member 80 are realized by a dispensing cap 220 alone; the functions of the adjusting member 61 and the operation lever 61f in the head portion 60 are realized by an adjusting member 261 and an operation portion 261f in a head portion 260; and the outer container 70 is not additionally provided around the container bodies 10. The description herein will therefore focus on the points different from the first embodiment.

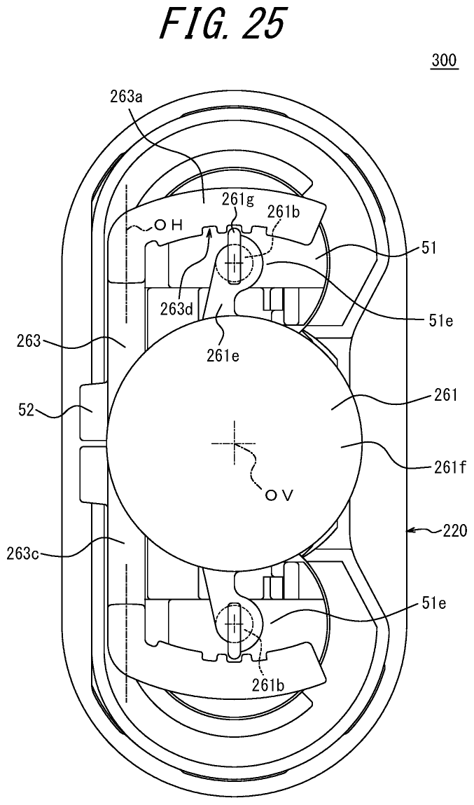

The dispensing cap 220 of the present embodiment is made of polypropylene and has a rectangular shape with rounded corners in the plan view (refer to FIG. 24). The dispensing cap 220 includes two circumferential walls 221 that are respectively mounted to the mouths 11 of the two container bodies 10, a top wall 223 that is contiguous with upper end portions of the circumferential walls 221, an upper circumferential wall 227 that extends further upward from an upper surface of the top wall 223, and an engagement protrusion 227a that extends to the outer side in the radial direction from the upper circumferential wall 227 and that is used to mount the lid 90 thereon by engaging with an inner circumferential surface of a lower portion of the outer circumferential wall 91 in the lid 90. The dispensing cap 220 is mounted to the container bodies 10 so that the circumferential walls 221 cover the mouths 11 from the outer side in the radial direction and that the top wall 223 covers the mouths 11 from above. Additionally, the dispensing cap 220 may be formed from other resins, such as polyethylene.

Each circumferential wall 221 is provided, on an inner circumferential surface thereof, with a female screw portion 221a. The female screw portion 221a protrudes to the inner side in the radial direction from the inner circumferential surface of the circumferential wall 221, and the female screw portion 221a is configured to be screw-engaged with the male screw portion 11a.

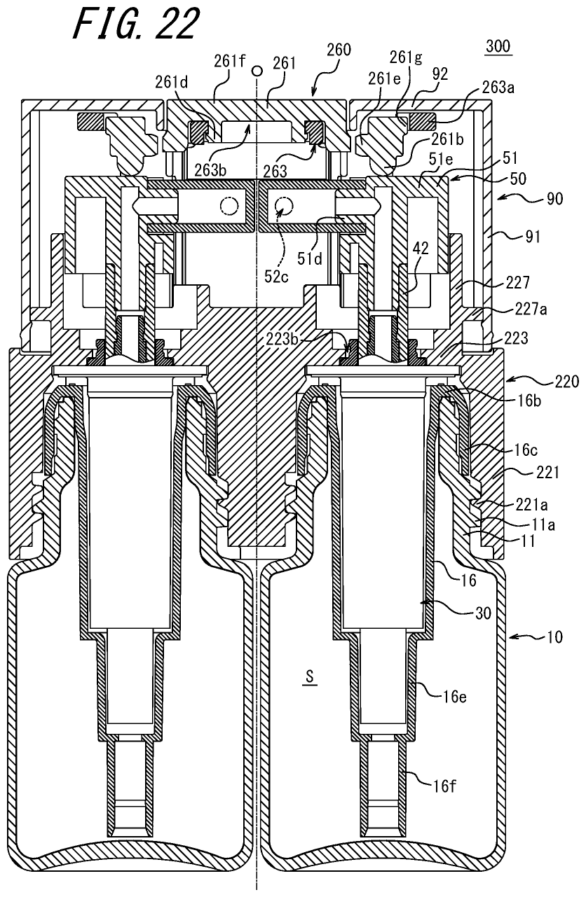

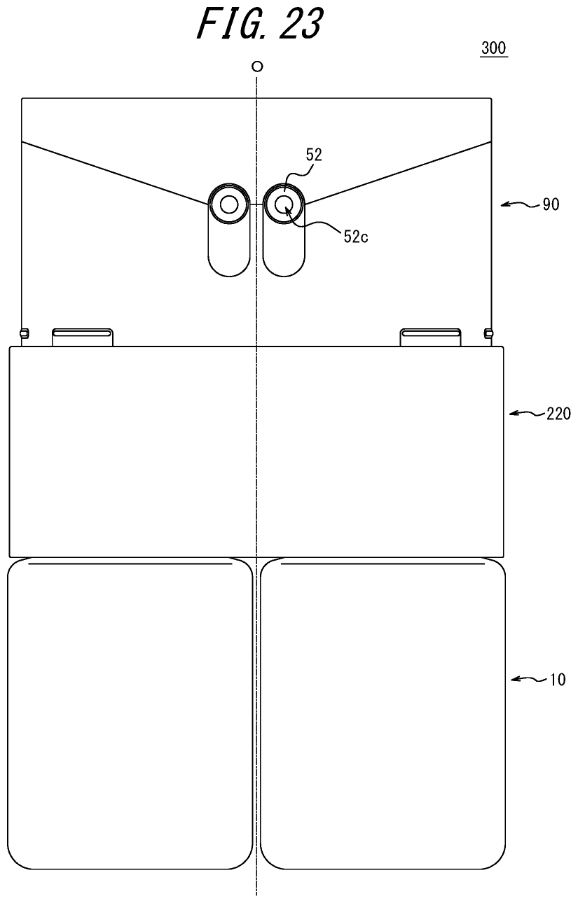

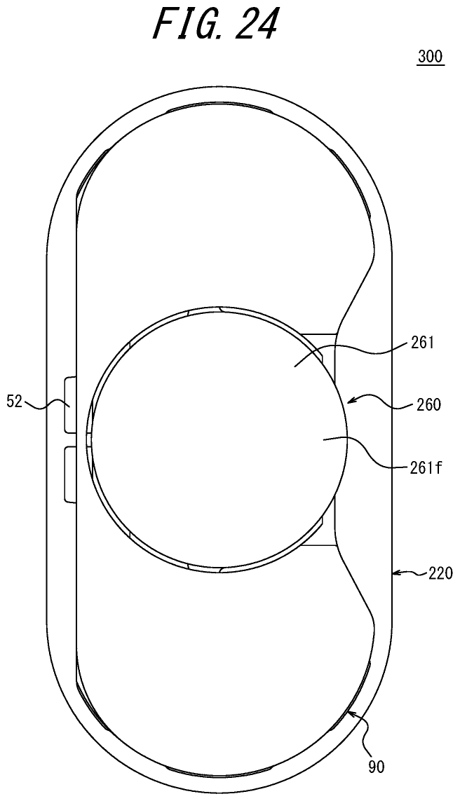

The top wall 223 of the dispensing cap 220 is provided with two communication holes 223b. As illustrated in FIG. 22, upper portions of the pumps 30 extend vertically through the communication holes 223b, so as to convey pressing force from the head portion 260 to the pumps 30.

Next, the head portion 260 will be explained. The head portion 260 includes an adjusting member 261 that depresses the respective pressure-receiving portions 51e of the two mounting members 51 of the two nozzle portions 50 at a stroke ratio desired by the user, and a pressing head 263 that can rotate about the axis OH extending in the substantially horizontal direction that is parallel to a direction in which the two container bodies 10 are arranged (refer to FIG. 25), to thereby depress the two stems 42 via the adjusting member 261.

In the present embodiment, the pressing head 263 is configured to be depressed in response to the operating portion 261f of the adjusting member 261 being pressed downward. In this way, a depressing operation of the pressing head 263 refers to a notion including a case of indirectly depressing the pressing head 263 by applying force to another member as in the present embodiment, without being limited to a case of directly depressing the pressing head 263.

As illustrated in FIG. 25, the adjusting member 261 includes an portion 261e that extends in the left/right direction (left/right direction in FIG. 22, which corresponds to the up/down direction in FIG. 25), pressing portions 261b that are formed on lower surfaces of both end portions in the longitudinal direction of the arm portion 261e, fitting protrusions 261g that protrude from upper portions of the pressing portions 261b in the left/right direction (up/down direction in FIG. 25), and a disk-shaped operation portion 261f provided at the middle in the longitudinal direction of the adjusting member 261. As illustrated in FIG. 22, the adjusting member 261 is mounted to the pressing head 263 by fitting a rotation shaft 261d of the adjusting member 261 to a rotation hole 263b provided in the pressing head 263, and the adjusting member 261 is rotatable about the rotation hole 263b (axis OV extending in the substantially vertical direction) (refer to FIG. 25).

The pressing head 263 includes a rotation shaft 263c defining the axis OH extending in the substantially horizontal direction, positioning arms 263a that extend rearward from both end portions in the left/right direction (up/down direction in FIG. 25) of the rotation shaft 263c, and the aforementioned rotation hole 263b.

The rotation shaft 263c of the pressing head 263 is configured to be rotatable around a sliding surface (which is not shown) provided in the lid 90. Thus, when the pressing head 263 is depressed in the direction toward the back of the plane of paper in FIG. 25 via the operation portion 261f, the pressing head 263 rotates about the rotation shaft 263c (axis OH extending in the substantially horizontal direction). Accordingly, the greater a distance (distance in the left/right direction FIG. 25) between the rotation shaft 263c (axis OH extending in the substantially horizontal direction) and a pressing portion 261b in the plan view, the greater a stroke of the pressing portion 261b that is depressed becomes, provided that the pressing head 263 is rotated through the same angle. A stroke of the corresponding stem 42 depressed by the pressing portion 261b becomes greater accordingly. It is therefore possible to relatively increase the amount of the content to be dispensed by the stem 42 (pump 30) depressed by one of the pressing portions 261b that is at a greater distance from the axis OH extending in the substantially horizontal direction, by rotating the adjusting member 261 about the axis OV extending in the substantially vertical direction to thereby make respective distances (distances in the left/right direction in FIG. 25) from the axis OH extending in the substantially horizontal direction to the two pressing portions 261b different from each other in FIG. 25. Thus, the ratio between the two kinds of contents to be dispensed can be changed.

In the present embodiment, rotation of the adjusting member 261 about the axis OV extending in the substantially vertical direction can be adjusted by rotating the operation portion 261f illustrated in FIG. 22 and FIG. 25 about the axis OV extending in the substantially vertical direction. By doing so, the arm portion 261e of the adjusting member 261 and the pressing portions 261b, which are provided at the ends of the arm portion 261e, rotate about the axis OV extending in the substantially vertical direction, and respective distances (distances in the left/right direction in FIG. 25) from the axis OH extending in the substantially horizontal direction to the two pressing portions 261b can be changed.

It is to be noted that in the present embodiment an angular position of the adjusting member 261 about the axis OV extending in the substantially vertical direction with respect to the pressing head 263 is determined, by fitting the plurality of fitting protrusions 261g, which are provided on the upper portions of the pressing portions 261b, in a plurality of recesses 263d provided in the corresponding positioning arm 263a of the pressing head 263. The user can change the angular position of the adjusting member 261 about the axis OV extending in the substantially vertical direction with respect to the pressing head 263, by further rotating the operating portion 261f about the axis OV extending in the substantially vertical direction to thereby fit the fitting protrusions 261g in different recesses 263d. Thus, the ratio of the two kinds of contents to be dispensed can be changed.

With the above configuration in which the fitting protrusions 261g are fitted in the recesses 263d, the user can easily see that the adjusting member 261 has been adjusted to an intended angular position. Further, the adjusting member 261 is prevented from shifting out of the angular position contrary to the intention of the user.

While the present disclosure has been described with reference to the drawings and examples, it is to be noted that various modifications and revisions may be implemented by those skilled in the art based on the present disclosure. Therefore, such changes and modifications are to be understood as included within the scope of this disclosure. For example, functions or the like included in each component can be rearranged without logical inconsistency, and a plurality of components can be combined together or divided. These are construed as being encompassed in the scope of the present disclosure.

For example, although in the first through the third embodiment, the container bodies 10 are laminated peelable containers (double containers), the present disclosure is not limited to these embodiments, and the container bodies 10 do not necessarily need to have double container configurations. For example, as the container bodies 10, high viscosity pump dispenser (HVD) containers having bottom portions provided with middle plates may be employed in place of double containers.

Further, although in the first through the third embodiment the adjusting members 61, 161, 261 are configured to indirectly press the stems 42 via the nozzle portions 50, 150 (mounting members 51, 151), the present disclosure is not limited to these embodiments, and the adjusting members 61, 161, 261 may be configured to directly press the stems 42.

Moreover, although in the first through the third embodiment the dispensing caps 20, 120, 220 are made of polypropylene or polyethylene, the present disclosure is not limited to these embodiments, and the dispensing caps 20, 120, 220 may be made of other synthetic resin materials.

Moreover, although in the first through the third embodiment the outer layer body 18 of each container body 10 is made of polyethylene resin or polyethylene terephthalate, the present disclosure is not limited to these embodiments, and it is only necessary that the outer layer body 18 and the inner layer body 17 have low compatibility with each other, and a material for the outer layer body 18 and a material for the inner layer body 17 can be changed in various ways.

Moreover, although in the first through the third embodiment the container bodies 10 are configured to be formed by extrusion blow molding, the present disclosure is not limited to these embodiments, and the container bodies 10 may be formed by biaxial stretch blow molding.

Moreover, each nozzle portion 50 in the first embodiment is configured to be provided, in the upper end portion thereof on the side adjacent to the axis OH extending in the substantially horizontal direction in the plan view, with the recess 51f that is recessed downward. In the second and the third embodiment also, recesses may be formed in upper end portions on the side adjacent to the axis OH extending in the substantially horizontal direction in the plan views.

Further, although the pipe P are fitted inside the second reduced-diameter portions 16f of the containing tubular portions 16 only in the second embodiment, pipes P may be provided in the dispensing containers 100, 300 according to the first and the third embodiment. In a case in which the container bodies 10 are double containers or HVD containers, pipes P are not essential components and may or may not be provided. In a case in which the container bodies 10 are normal containers that are neither double containers nor HVD containers, pipes P are preferably provided, although this is not essential.

In the first and the second embodiment, the pressing heads 63, 163 are configured to cover the adjusting members 61, 161 from above, the present disclosure is not limited to these embodiments. For example, the adjusting members 61, 161 may be mounted on upper surfaces of the pressing heads 63, 163 so as to be relatively rotatable, and the pressing portions 61b, 161b of the adjusting members 61, 161 may be configured to extend downward through openings provided in the pressing heads 63, 163 so as to be capable of pressing the mounting members 51, 151 or the like.

Further, although in the first through the third embodiment each of the adjusting members 61, 161, 261 is configured to press each stem 42 by the corresponding pressing portion 61b, 161b, 261b via the corresponding mounting member 51, 151, the present disclosure is not limited to these embodiments. The adjusting members 61, 161, 261 may be configured so that each stem 42 is pressed by a plurality of pressing portions 61b, 161b, 261b.

### REFERENCE SIGNS LIST

10 Container body

11 Mouth

11a Male screw portion

12 Shoulder

13 Trunk

14 Reduced-diameter portion

15 Bottom

16 Containing tubular portion

16a Tubular portion

16b Flange portion

16c Upper outer wall

16d Stepped portion

16e First reduced-diameter portion

16f Second reduced-diameter portion

17 Inner layer body

18 Outer layer body

19 Inner plug member

19a Inner plug

19b Circumferential wall

20 Dispensing cap

21 Outer circumferential wall

21a Female screw portion

22 Upper circumferential wall

22a Stepped portion

22b Outer circumferential rib

23 Top wall

23a Fitting tube

23b Communication hole

30 Pump

31 Lower assembly

33 Cylinder

33a Tubular-shaped portion

33b Flange portion

33c Stepped portion

33d Fitting tube

33e Draw valve seat

34 Second locking member

35 Draw valve member

35a Support frame

35b Upper wall

35c Draw valve

35d Support member

41 Upper assembly

42 Stem

42a Coupling tubular portion

42b Stepped portion

42c Large-diameter portion

43 Annular piston

43a Outer wall

43b Inner wall upper end portion

43c Inner wall lower end portion

44 Piston guide

44a Guide body

44c Discharge valve hole

44d Discharge valve seat

44e Lower end portion

46 First locking member

49 Urging spring

50 Nozzle portion

51 Mounting member

51a Perpendicular tubular portion

51b Ceiling wall

51c Circumferential wall

51d Horizontal tubular portion

51e Pressure-receiving portion

51f Recess

52 Dispensing port member

52a Fitting tubular portion

52b Dispensing port tubular portion

52c Dispensing port

60 Head portion

61 Adjusting member

61b Pressing portion

61d Rotating hole

61e Arm portion

61f Operation lever

61g Abutment portion

63 Pressing head

63a Pressing plate

63b Rotation shaft

63c Rotation shaft

63h Through hole

70 Outer container

71 Side wall portion

72 Bottom portion

73 Positioning wall

80 Coupling member

82 Upper wall

83 Upper tubular wall

84 Side wall portion

84a Inner rib

85 Partition wall

90 Lid

91 Outer circumferential wall

92 Upper wall

100, 200, 300 Dispensing container

120 Dispensing cap

121 Inner circumferential wall

121a Female screw portion

123 Top wall

123b Communication hole

125 Outer circumferential wall

127 Upper circumferential wall

150 Nozzle portion

151 Mounting member

151a Vertical tubular portion

151d Horizontal tubular portion

151e Pressure-receiving portion

152 Dispensing port member

152a Fitting tubular portion

152b Dispensing port tubular portion

152c Dispensing port

153 Flexible tube

160 Head portion

161 Adjusting member

161b Pressing portion

161d Rotation shaft

163 Pressing head

163a Pressing plate

163b Rotating hole

163c Hinge portion

165 Tab

220 Dispensing cap

221 Circumferential wall

221a Female screw portion

223 Top wall

223b Communication hole

227 Upper circumferential wall

227a Engagement protrusion

260 Head portion

261 Adjusting member

261b Pressing portion

261d Rotation shaft

261e Arm portion

261f Operation portion

261g Fitting protrusion

263 Pressing head

263a Positioning arm

263b Rotating hole

263c Rotation shaft

263d Recess

O Axis

OH Axis extending in substantially horizontal direction

OV Axis extending in substantially vertical direction

S Containing space

1. A dispensing container, comprising:
two container bodies configured to respectively contain two kinds of contents;
two pumps respectively including two protruding stems configured to be depressed in an upwardly urged state, the two pumps being configured to respectively pump the two kinds of contents in the two container bodies upward in response to the two stems being depressed;
an adjusting member configured to directly or indirectly press the two stems and configured to be rotatable about an axis extending in a substantially vertical direction that is located between the two container bodies in a plan view; and
a pressing head configured to, in response to a depressing operation, rotate about an axis extending in a substantially horizontal direction that is parallel to a direction in which the two container bodies are arranged, to thereby depress the two stems via the adjusting member, wherein
the adjusting member includes a plurality of pressing portions by which the two stems are directly or indirectly pressed, and when the adjusting member is rotated about the axis extending in the substantially vertical direction, one of the plurality of pressing portions on a side of one of the two stems approaches the axis extending in the substantially horizontal direction in the plan view, whereby a depressing stroke of the one of the plurality of pressing portions on the side of the one of the two stems in response to a depressing operation of the pressing head becomes shorter, and another one of the plurality of pressing portions on a side of another one of the two stems moves away from the axis extending in the substantially horizontal direction, whereby a depressing stroke of the other one of the plurality of pressing portions on the side of the other one of the two stems in response to the depressing operation of the pressing head becomes longer.

2. The dispensing container according to claim 1, wherein
the plurality of pressing portions of the adjusting member is configured to protrude downward from both end portions of an arm portion extending substantially in the horizontal direction, and the adjusting member is configured to be mounted to the pressing head so as to be rotatable about the axis extending in the substantially vertical direction.

3. The dispensing container according to claim 2, wherein
the adjusting member includes an operation lever that is orthogonal to a longitudinal direction of the arm portion and that protrudes to a side opposite to the axis extending in the substantially horizontal direction in the plan view, and the operation lever is configured to protrude in the substantially horizontal direction through a through hole provided in the pressing head.

4. The dispensing container according to claim 1, wherein
the adjusting member is configured to be coupled to a tab provided on an upper surface of the pressing head, so that rotation of the adjusting member is adjustable by rotating the tab.

5. The dispensing container according to claim 1, wherein
two nozzle portions are respectively mounted to the two stems, the two nozzle portions being configured to respectively guide the two kinds of contents pumped from the two pumps to two dispensing ports, and the adjusting member is configured to press the two stems via the nozzle portions.

6. The dispensing container according to claim 5, wherein
each of the two the nozzle portions is configured to be provided, in an upper end portion thereof on a side adjacent to the axis extending in the substantially horizontal direction in the plan view, with a recess that is recessed downward.

7. The dispensing container according to claim 5, wherein
each of the two nozzle portions is configured to be coupled to the corresponding dispensing port via a flexible tube.
